(19) United States
(12) Patent Application Publication
(10) Pub. No.: US 2012/0096674 A1
(43) Pub. Date: Apr. 26, 2012

(54) REPLACEMENT WHEEL FOR WALKER

(76) Inventor: Igor Cvetanovski, Bolingbrook, IL (US)

(21) Appl. No.: 12/854,053

(22) Filed: Oct. 23, 2010

(51) Int. Cl. B60B 33/00

(52) U.S. Cl. 16/45

(57) ABSTRACT

This is a replacement wheel for a medical walker. This replacement wheel is 9 inches in diameter. The wheel itself is made of durable plastic and is surrounded with rubber. The wheel is steel bolted to an aluminum shaft with a protective plastic cap at its bottom. The shaft of the replacement wheel has 7 positioning holes. To use the replacement wheel simply remove old wheels from walker and adjustable shaft for most manufactured medical walkers and the new replacement wheel fits securely into the shaft. The positioning holes can be adjusted to the correct height needed.

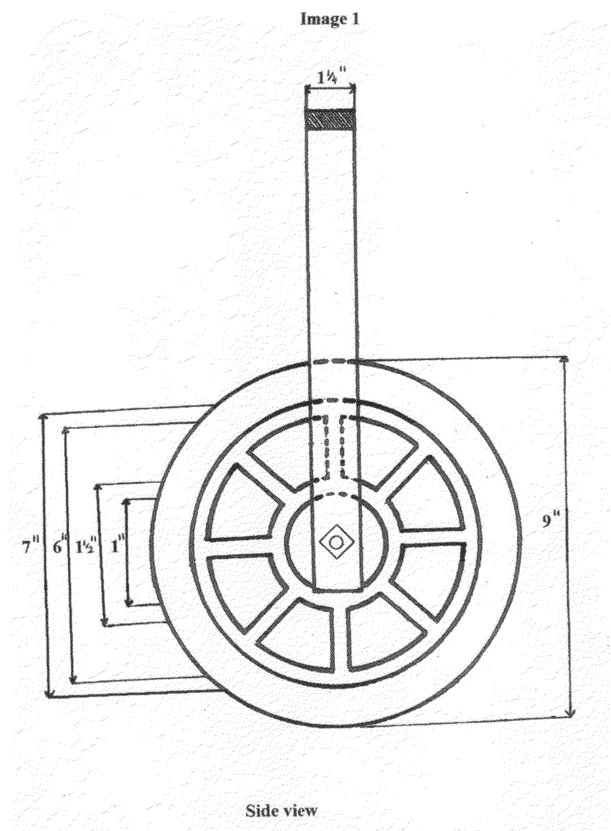

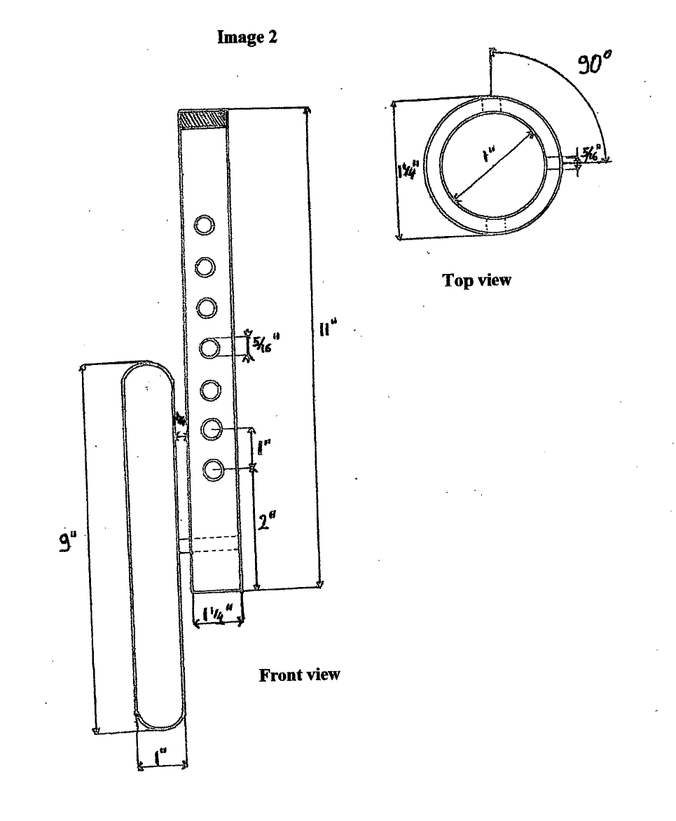

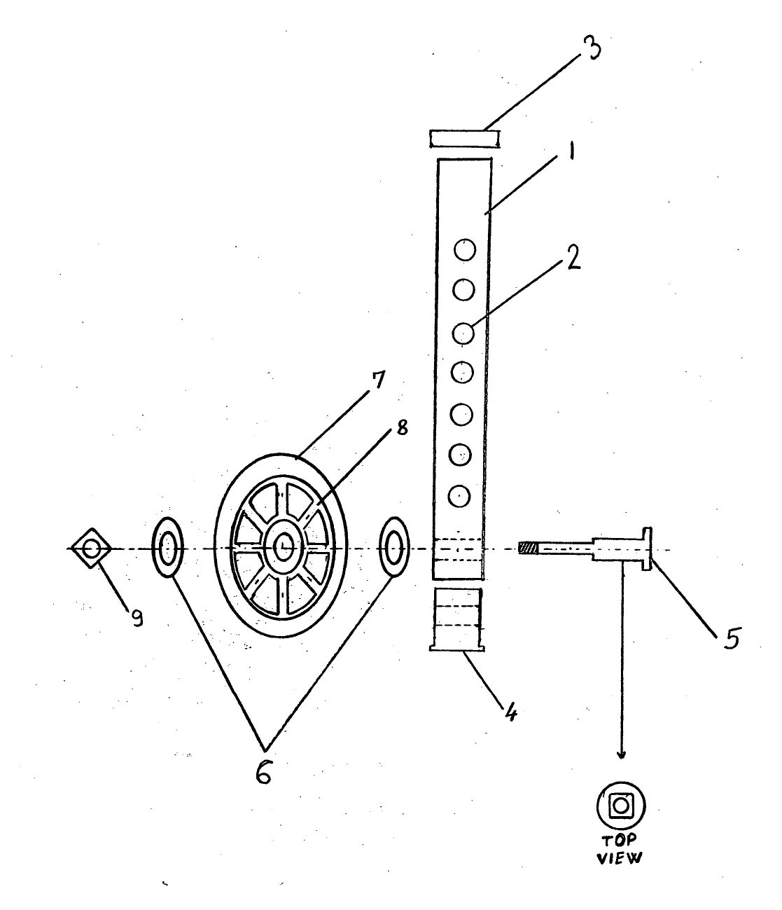

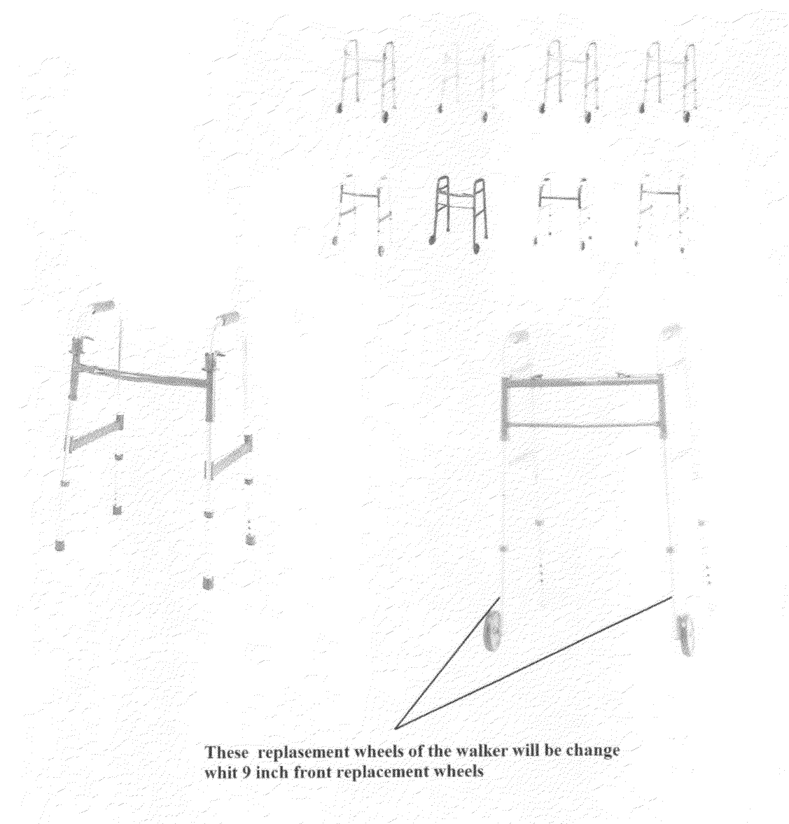

Caster wheel consisting of a plastic hub surrounded by a rubber wheel which is Attached by a single bolt to the aluminum adjustable leg, which has seven adjustment settings. left and right 9″ replacement wheel for walker.

1 Aluminum adjustable leg
2 Adjustment settings
3 Protection plastic
4 Protection plastic
5 Steel bolt
6 Steel washers
7 Robber
8 Plastic rim
9 Steel nuts

The 9 inch replacement wheel for walker is present on the next image. On image 1 you can see how is looking the patent from the side with all the dimension, on Image 2 have how is looking from the front and the same image on the right corner you have top view on the aluminum shaft with all dimensions.

And on the last image image you have all the parts on the walker.

1. 9″ replacement wheel for walker is different then others because is larger. The large wheel will allow for better movement of the walker, it provides less resistance to rough terrain while allowing easy gliding on smooth surfaces. The safety factor will increase because the large wheel keeps the walker from tilting or toppling over if exposed to rocky or uneven surfaces.
